(19) United States
(12) Patent Application Publication
(10) Pub. No.: US 2025/0139146 A1
(43) Pub. Date: May 1, 2025

(54) SYSTEMS AND METHODS FOR HIGHLIGHTING KEY WORDS AND PHRASES FROM ANSWERS

(71) Applicant: RELX Inc., Miamisburg, OH (US)

(72) Inventors: Soha Khazaeli, Cary, NC (US); Jake Nelson, Holly Springs, NC (US); Taylor Hearn, Durham, NC (US)

(73) Assignee: RELX Inc., Miamisburg, OH (US)

(21) Appl. No.: 18/925,428

(22) Filed: Oct. 24, 2024

Related U.S. Application Data
(60) Provisional application No. 63/593,363, filed on Oct. 26, 2023.

(51) Int. Cl. G06F 16/34; G06F 16/332

(52) U.S. Cl. CPC G06F 16/34; G06F 16/3329

(57) ABSTRACT

In embodiment, a method of displaying an answer of a question-answer pair in response to a natural language search query includes receiving, from a Bidirectional Encoder Representations from Transformers (BERT) model, an array of attention matrices for the question-answer pair, where each attention matrix of the array of attention matrices includes an array of attribution values, generating a total attribution value for each word of an answer of the question-answer pair from the array of attention matrices, and displaying the answer on an electronic display, wherein one or more words of the answer is highlighted based on the total attribution values for each word.

### CROSS-REFERENCE TO RELATED APPLICATIONS

This application claims priority to U.S. Provisional Patent Application No. 63/593,363 filed on Oct. 26, 2023, the contents of which are hereby incorporated by reference in its entirety.

### BACKGROUND

Question-answer pair searching involves a user submitting a question in the form of a natural language query to an embedding model. Each passage of content within a document corpus is indexed into a database using the same embedding model. The system then retrieves and produces one or more question-answer pairs, with the answer being a potential answer to the question that was submitted. In a second step, the answers are re-ranked using another model that takes in question-answer pairs as input and returns scores as output. The scored answers are presented to the user in a results-list or other graphical interface. However, some answers may have long spans of text, and it may be difficult for the user to quickly see and understand the important parts of the text, as well as have confidence in the model that it produced a reliable answer.

### SUMMARY

To solve the above-referenced problems, embodiments of the present disclosure highlight important words in a resulting answer so that the user can both trust the underlying model and quickly understand the important words and phrases of the proposed answer.

In one embodiment, a method of displaying answers of question-answer pairs in response to a natural language search query includes receiving a natural language query from a graphical user interface, generating a plurality of question-answer pairs from the natural language query, and inputting the plurality of question-answer pairs into a Bidirectional Encoder Representations from Transformers (BERT) model. The BERT model generates an array of attention matrices for each question-answer pair of the plurality of question-answer pairs, wherein each attention matrix of the array of attention matrices produces an array of attribution values. The method further includes inputting an output of the BERT model into a classifier, wherein the classifier classifies each question-answer pair as a satisfactory answer or an unsatisfactory answer, and displaying each satisfactory answer. One or more words of each satisfactory answer is highlighted based at least in part on the array of attribute values.

In another embodiment, a system of displaying answers of question-answer pairs in response to a natural language search query includes one or more processors, an electronic display, and a non-transitory computer-readable medium storing instructions that, when executed by the one or more processors, causes the one or more processors to receive a natural language query from a graphical user interface, and generate a plurality of question-answer pairs from the natural language query, input the plurality of question-answer pairs into a Bidirectional Encoder Representations from Transformers (BERT) model. The BERT model generates an array of attention matrices for each question-answer pair of the plurality of question-answer pairs, wherein each attention matrix of the array of attention matrices produces an array of attribution values. The instructions further cause the one or more processors to input an output of the BERT model into a classifier, wherein the classifier classifies each question-answer pair as a satisfactory answer or an unsatisfactory answer, and display each satisfactory answer, wherein one or more words of each satisfactory answer is highlighted based at least in part on the array of attribute values.

In embodiment, a method of displaying an answer of a question-answer pair in response to a natural language search query includes receiving, from a Bidirectional Encoder Representations from Transformers (BERT) model, an array of attention matrices for the question-answer pair, where each attention matrix of the array of attention matrices includes an array of attribution values, generating a total attribution value for each word of an answer of the question-answer pair from the array of attention matrices, and displaying the answer on an electronic display, wherein one or more words of the answer is highlighted based on the total attribution values for each word.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a query/answer pair having attributions according to one or more embodiments of as described and illustrated herein.

FIG. 2 illustrates an example process for analyzing a query/answer pair according to one or more embodiments described and illustrated herein.

FIG. 3 illustrates an example attention matrix according to one or more embodiments described and illustrated herein.

FIG. 4 illustrates an example BERT output comprising an array of attention matrices according to one or more embodiments described and illustrated herein.

FIG. 5A illustrates an example BERT output comprising an array of attention matrices and selected sub-set of attention matrices according to one or more embodiments described and illustrated herein.

FIG. 5B illustrates another example BERT output comprising an array of attention matrices and selected sub-set of attention matrices according to one or more embodiments described and illustrated herein.

FIG. 6 illustrates a process for comparing a BERT output against a ground truth for determining loss according to one or more embodiments described and illustrated herein.

FIG. 7 illustrates a process for determining optimal sub-set of attention matrices of a BERT output according to one or more embodiments described and illustrated herein.

FIG. 8 illustrates two example highlighted answers according to one or more embodiments described and illustrated herein

FIG. 9 illustrates an example computing device for highlighting words of an answer according to one or more embodiments described and illustrated herein.

### DETAILED DESCRIPTION

Embodiments of the present disclosure generate query/answer pairs having highlighted important words in response to a query presented by a user. The highlighted words present within the answers allow a user to quickly view the important words, while also instilling confidence in the user that the system understands what is important about the question presented.

More particularly, embodiments of the present disclosure leverage attention matrices generated by a trained Bidirectional Encoder Representations from Transformers (BERT) model to calculate attributions for each word token in a resulting query/answer pair. These attributions are used to determine the most highly relevant tokens in the answer so that these words represented by the highly relevant word tokens may be highlighted. The highlighted words are the most important words of the answer, and both instill confidence in the user that the model is accurate and provided a quick visual for the user to see the most important part of the answer.

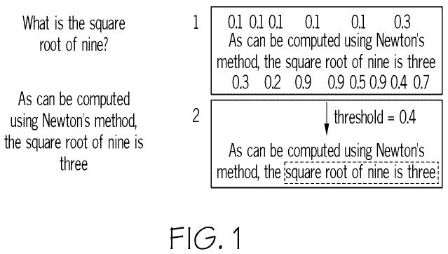

FIG. 1 illustrates an example where the user asks the question “What is the square root of nine?” The user may enter the question into a text box, or the user may speak the question using his or her voice. The spoken language can then be converted into text by any known or yet-to-be-developed speech-to-text algorithms.

As shown in the bottom left of FIG. 1, the system displays the answer “As can be computed using Newton's method, the square root of nine is three.” Attributions representing the importance of each word token are calculated. The answer in the upper right box of FIG. 1 shows an attribution above each word token of the answer. For example, the word token “can” has an attribution of 0.1, the word token “Newton's” has an attribution of 0.3, and the word token “root” has an attribution of 0.9.

To determine the most important word token of the answer, a threshold may be applied such that those word tokens with attributions over the threshold are highlighted in the answer. Embodiments are not limited by any threshold value. In the example of FIG. 1, the threshold is set to 0.4. Each word token having an attribution greater than 0.4 is highlighted in the answer that is presented to the user. Thus, in the example of FIG. 1, the phrase “square root of nine is three” is highlighted by highlighting each word token in the phrase because all of the attributions are greater than 0.4.

Previous methods of calculating attributions (gradient-based attribution methods) tend to require computing multiple gradients, which is a computationally expensive and time intensive process. This is because each gradient takes longer to compute than a forward pass, since it requires finding the partial derivative of every weight of the neural network. Thus, it is not realistic to apply a gradient-based attribution method every time a user poses a question to the question-answer system. Such a system would respond slowly, and consume too much power. Thus, gradient-based attribution methods cannot be utilized in a large-scale data retrieval system such as a legal research platform where thousands of users are running thousands of queries that require almost immediate results.

The BERT model already computes attention matrices as part of its forward pass. The attention matrices are the outputs of the self-attention layers of the BERT model, and indicate how much each token in a sequence is paying attention to the other tokens. Embodiments of the present disclosure leverage these attention matrices of the BERT model to determine token attributions in a fast summation operation rather than computationally expensive operations, such as gradient calculation. Therefore, the methods of the present disclosure can be employed in large-scale data retrieval systems in a fast, economical and reliable manner.

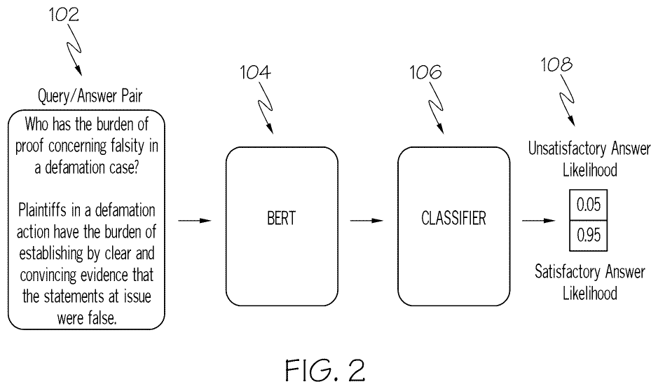

Referring now to FIG. 2, an example process for analyzing a query/answer pair 102 (also referred to herein as a “question-answer pair”) is illustrated. A query/answer pair 102 for a query is provided as input to a BERT model 104. As a non-limiting example, the BERT model 104 may be a legal BERT model trained on legal documents, such as case law. The output of the BERT model 104 is provided to a classifier 106, which produces a determination 108 as to whether the answer is a satisfactory answer or an unsatisfactory answer. The classifier 106 may be any known or yet-to-be developed classifier model, such as a feed-forward neural network classifier. In some embodiments, the function of the classifier 106 is provided by the BERT model 104 and is not a separate model. For example, the last layer of the BERT model 104 may be a classification layer. The BERT model 104 may output a probability for each class (i.e., a satisfactory answer or an unsatisfactory answer), and this probability value is used to determine whether the answer is satisfactory or not. In the example of FIG. 2, the answer has a probability of a satisfactory answer of 0.95 and is therefore selected as a satisfactory answer.

As stated above, the BERT model 104 produces intermediate data in the form of attention matrices that give the importance of each token to every other token in the answer. Embodiments of the present disclosure use the importance of each answer token to the query to find the attributions to each word of a query/answer pair 102.

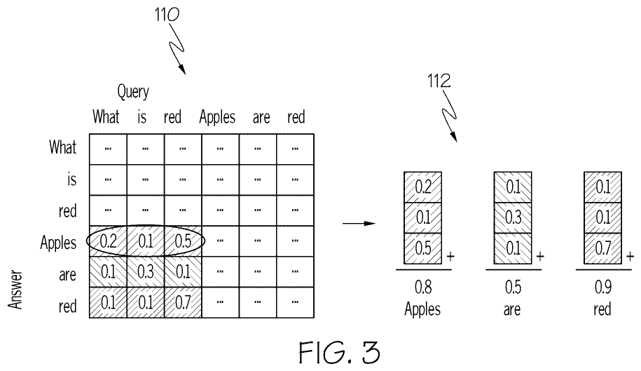

FIG. 3 illustrates a simple attention matrix 110 as an example. The attention matrix 110 comprises the query word tokens in the columns and the answer word tokens in the rows.

The values of each word token in the answer are summed to produce a total value for each token. In the example of FIG. 3, for the word token “Apples,” it has a value of 0.2 for word token “What,” a value of 0.1 for word token “is,” and a value of 0.5 for word token “red” of the query. Thus, the word token “Apple” receives a total value of 0.8. In this example, the word token “red” as a total value of 0.9 and is the most important word according to the attention matrix 110.

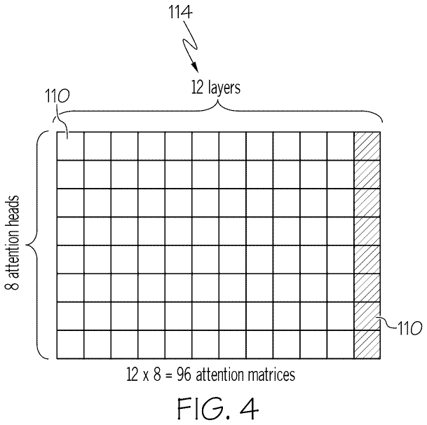

The BERT model 104 used to classify the question-answer pairs generates many attention matrices 110. Thus, it becomes desirable to select the attention matrices that will produce the optimal results with respect to determining the most important words of an answer. FIG. 4 illustrates an example 12×8 matrix of individual attention matrices, where each block is an individual attention matrix 110.

The output of the example BERT model 104 of FIG. 4 includes eight attention heads that relating to different features and twelve sequential layers, with each individual attention head and individual layer combination producing an individual attention matrix. Some attention heads may be redundant, and some attention matrices may be less valuable than others. Accordingly, it may be desirable to select an optimal combination of attention matrices to calculate the scores for the answer tokens.

An initial attempt calculated the token scores using the attention matrices of all of the attention heads of the last layer, as shown by the dark attention matrices in the last column of the BERT output 114 shown in FIG. 4. However, this approach achieved poor results and therefore a method of selecting the best attention matrices was developed and applied.

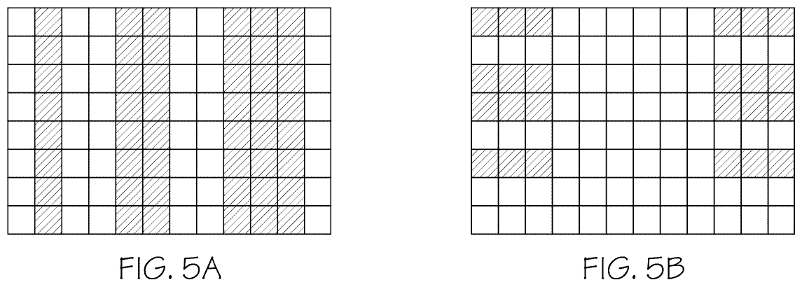

FIG. 5A and FIG. 5B illustrate two different potential sets of selected attention matrices, where the dark blocks represent the selected attention matrices. FIG. 5A shows an example case where the attention matrices of entire layers are selected to calculate the attributions for the word tokens. In FIG. 5B, only some attention matrices of various selected layers are selected to calculate the attributions for the word tokens.

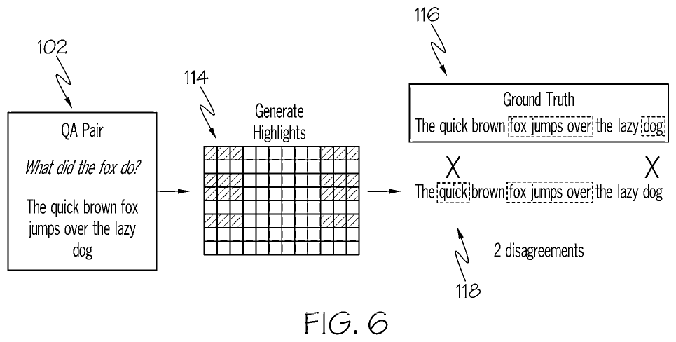

To determine the optimal attention matrices to calculate the attributions for the word tokens, embodiments of the present disclosure utilize a loss function that uses the layers and heads as hyperparameters. Referring now to FIG. 6, a training set with query/answer pairs 102 and ground truth 116 highlights was used. The each query/answer pair 102 was used to generate a BERT output 114 that was further used to generate answer 118 having highlighted words. A loss was calculated between the highlighted words of the answer 118 and the highlighted words of the ground truth 116. Thus, the loss is proportional to the number of disagreements (i.e., Hamming distance) between the answer 118 highlighted terms and the ground-truth highlighted terms. In the example of FIG. 6, there are two disagreements.

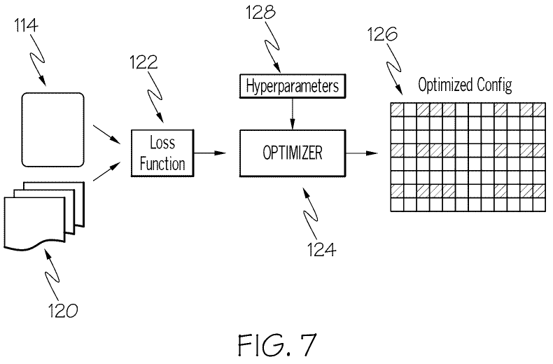

Referring to FIG. 7, an optimizer 124 is used in conjunction with the hyperparameters 128 (i.e., the heads and layers) to find an optimal sub-set of attention matrices 126 of the BERT output 114. Any known or yet-to-be-developed optimization algorithm may be utilized. The optimization algorithm of the optimizer 124 may be a Bayesian optimization, such as provided by OpenBox, as a non-limiting example.

In the workflow of FIG. 7, the BERT outputs 114 and a training set 120 of ground truths are provided as input to a loss function 122, which calculates the loss between the BERT outputs 114 and the training sets as described above with respect to FIG. 6. The loss is then provided to the optimizer 124, along with the hyperparameters 128 of the individual BERT output 114 (i.e., the layers and heads) that produced the calculated loss. In other words, the highlighted word selections as outputs of the BERT model 104 and the highlighted word selections of the training set 120 are provided as input into the loss function. The output of the loss function 122 and the hyperparameters are provided as input into the optimizer 124, which then calculates the optimal sub-set of attention matrices 126.

This optimal sub-set of attention matrices 126 may then be used to select highlighted words of answers 118 that are presented to a user. As stated above, the values for the word tokens 112 of the answers are summed using all of the attention matrices of the optimal sub-set of attention matrices 126. The word tokens 112 meeting a threshold are highlighted in the answer that is presented to the user. The highlighted words provide the user with a quick visual for the user to see the most important part of the answer, and also instill confidence in the user that the model is accurate.

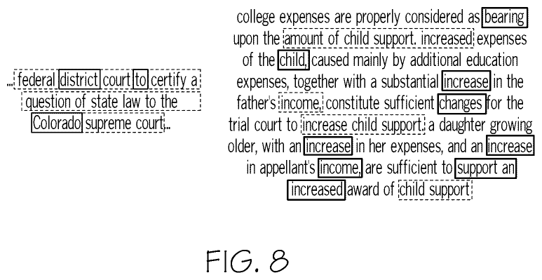

Post-processing may be used to provide a better result for the user in some embodiments. In some cases, words of a phrase may be left out because they did not meet the threshold, or words may be in isolation that meet the threshold but are not surrounded by any other words that meet the threshold. In the left-hand example of FIG. 8, the words “district” “to” and “Colorado” were not selected for highlighting. However, it makes sense to the reader to include these words as highlighted with the rest of the phrase. During the post-processing process, these words may be highlighted. In the right-hand example, the words bearing, “child,” “increase,” “changes,” “income and “support an increase” were highlighted but are in isolation and do not fit with the other phrases that are highlighted. Thus, they may have their highlighting removed by the post-processing process.

The post-processing process may use heuristic rules to determine when to add or remove highlighting to or from words. For example, nearby spans that should be combined are merged with neighboring spans. If there are too many spans, the system may keep only the top number of spans.

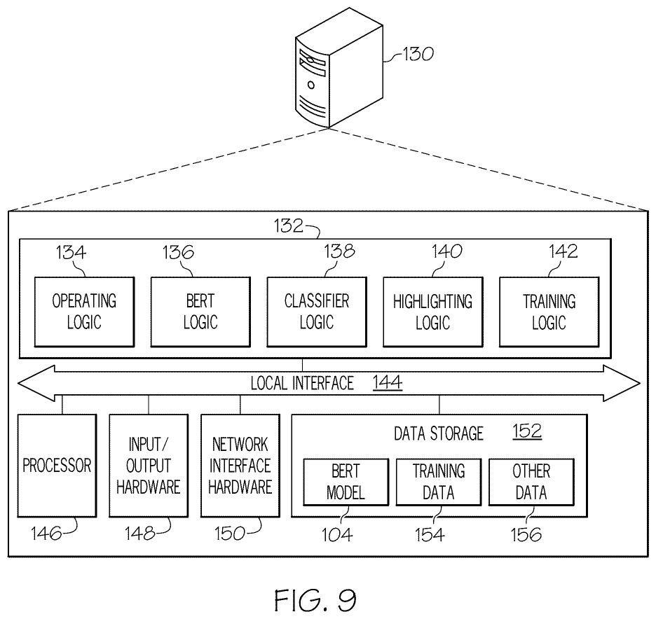

Embodiments of the present disclosure may be implemented by a computing device, and may be embodied as computer-readable instructions stored on a non-transitory memory device. Referring now to FIG. 9, an example system for automatically recommending electronic documents as a computing device 130 is schematically illustrated. The example computing device 130 provides a system for highlighting words of an answer to a query, and/or a non-transitory computer usable medium having computer readable program code for highlighting words of an answer to a query embodied as hardware, software, and/or firmware, according to embodiments shown and described herein. While in some embodiments, the computing device 130 may be configured as a general purpose computer with the requisite hardware, software, and/or firmware, in some embodiments, the computing device 130 may be configured as a special purpose computer designed specifically for performing the functionality described herein. It should be understood that the software, hardware, and/or firmware components depicted in FIG. 9 may also be provided in other computing devices external to the computing device 130 (e.g., data storage devices, remote server computing devices, and the like).

As also illustrated in FIG. 9, the computing device 130 (or other additional computing devices) may include a processor 146, input/output hardware 148, network interface hardware 150, a data storage component 152 (which may store BERT model data (e.g., data relating to BERT model 104), training data 154 (e.g., ground truth 116 examples and data), and any other data 156 for performing the functionalities described herein), and a non-transitory memory component 132. The memory component 132 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 132 may be configured to store operating logic 134, BERT logic 136 for determining attribution values and determining answers, classifier logic 138 for determining if an answer is satisfactory or not, highlighting logic 140 for highlighting words of the answer, and (each of which may be embodied as computer readable program code, firmware, or hardware, as an example). It should be understood that the data storage component 152 may reside local to and/or remote from the computing device 130, and may be configured to store one or more pieces of data for access by the computing device 1002 and/or other components.

A local interface 144 is also included in FIG. 9 and may be implemented as a bus or other interface to facilitate communication among the components of the computing device 130.

The processor 146 may include any processing component configured to receive and execute computer readable code instructions (such as from the data storage component 152 and/or memory component 132). The input/output hardware 148 may include virtual reality headset, display device, keyboard, mouse, printer, camera, microphone, speaker, touch-screen, and/or other device for receiving, sending, and/or presenting data. The network interface hardware 150 may include any wired or wireless networking hardware, such as a modem, LAN port, wireless fidelity (Wi-Fi) card, WiMax card, mobile communications hardware, and/or other hardware for communicating with other networks and/or devices.

Included in the memory component 132 may be the operating logic 134, BERT logic 136, classifier logic 138, highlighting logic 140, and training logic 142. The operating logic 134 may include an operating system and/or other software for managing components of the computing device 1002. The BERT logic 136 may reside in the memory component 132 and may be configured to generate attributions and potential answers to a query. The classifier logic 138 also may reside in the memory component 132 and may be configured to classify potential answers as satisfactory or unsatisfactory. The highlighting logic 140 includes logic to apply an attribution threshold to select which words of an answer to highlight when displaying the answer to a user. The training logic 142 includes logic to train an optimizer 124 to select optimal sub-set of attention matrices 126 of a BERT output.

The components illustrated in FIG. 9 are merely exemplary and are not intended to limit the scope of this disclosure. More specifically, while the components in FIG. 9 are illustrated as residing within the computing device 130, this is a non-limiting example. In some embodiments, one or more of the components may reside external to the computing device 130.

It should now be understood that embodiments of the present disclosure are directed to systems and methods that generate question-answer pairs having highlighted important words in response to a query presented by a user. The highlighted words present within the answers allow a user to quickly view the important words, while also instilling confidence in the user that the system understands what is important about the question presented. More particularly, embodiments of the present disclosure leverage attention matrices generated by a trained Bidirectional Encoder Representations from Transformers (BERT) model to calculate attributions for each word token in a resulting question-answer pair. These attributions are used to determine the most highly relevant tokens in the answer so that these words represented by the highly relevant tokens may be highlighted. The highlighted words are the most important words of the answer, and both instill confidence in the user that the model is accurate and provided a quick visual for the user to see the most important part of the answer.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can per similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A method of displaying answers of question-answer pairs in response to a natural language search query, the method comprising:
receiving a natural language query from a graphical user interface;
generating a plurality of question-answer pairs from the natural language query;
inputting the plurality of question-answer pairs into a Bidirectional Encoder Representations from Transformers (BERT) model, wherein the BERT model generates an array of attention matrices for each question-answer pair of the plurality of question-answer pairs, wherein each attention matrix of the array of attention matrices produces an array of attribution values;
inputting an output of the BERT model into a classifier, wherein the classifier classifies each question-answer pair as a satisfactory answer or an unsatisfactory answer; and
displaying each satisfactory answer, wherein one or more words of each satisfactory answer is highlighted based at least in part on the array of attribution values.

2. The method of claim 1, further comprising, for each satisfactory answer, generating a total attribution value for each word of the satisfactory answer from an individual array of attention matrices associated with the satisfactory answer, wherein each word having a total attribution value above a threshold value is highlighted.

3. The method of claim 2, wherein an attribution value for each word of the satisfactory answer is generated by:
selecting a sub-set of attention matrices of the array of attention matrices; and
for each word of the satisfactory answer, summing attribution values of the sub-set of attention matrices.

4. The method of claim 3, wherein the sub-set of attention matrices is selected by a loss function and an optimization algorithm.

5. The method of claim 4, wherein the array of attention matrices comprises a plurality of heads and a plurality of layers that are provided as input to the optimization algorithm.

6. The method of claim 1, further comprising applying a post-processing process that does one or more of the following: adds highlighting to one or more words being adjacent on both sides of word having highlighting, and removes highlighting from one or more words having a lowest total attribution when a maximum number of highlighted phrases is exceeded.

7. The method of claim 1, wherein the classifier is a layer of the BERT model.

8. A system of displaying answers of question-answer pairs in response to a natural language search query, the system comprising:
one or more processors;
an electronic display; and
a non-transitory computer-readable medium storing instructions that, when executed by the one or more processors, causes the one or more processors to:
receive a natural language query from a graphical user interface;
generate a plurality of question-answer pairs from the natural language query;
input the plurality of question-answer pairs into a Bidirectional Encoder Representations from Transformers (BERT) model, wherein the BERT model generates an array of attention matrices for each question-answer pair of the plurality of question-answer pairs, wherein each attention matrix of the array of attention matrices produces an array of attribution values;
input an output of the BERT model into a classifier, wherein the classifier classifies each question-answer pair as a satisfactory answer or an unsatisfactory answer; and
display each satisfactory answer, wherein one or more words of each satisfactory answer is highlighted based at least in part on the array of attribution values.

9. The system of claim 8, wherein the instructions cause the one or more processors to further generate a total attribution value for each word of the satisfactory answer from an individual array of attention matrices associated with the satisfactory answer, and wherein each word having a total attribution value above a threshold value is highlighted.

10. The system of claim 9, wherein an attribution value for each word of the satisfactory answer is generated by:
selecting a sub-set of attention matrices of the array of attention matrices; and
for each word of the satisfactory answer, summing attribution values of the sub-set of attention matrices.

11. The system of claim 10, wherein the sub-set of attention matrices is selected by a loss function and an optimization algorithm.

12. The system of claim 11, wherein the array of attention matrices comprises a plurality of heads and a plurality of layers that are provided as input to the optimization algorithm.

13. The system of claim 8, further comprising applying a post-processing process that does one or more of the following: adds highlighting to one or more words having a total attribution value less than a first threshold, and removes highlighting from one or more words having a total attribution value greater than a second threshold.

14. The system of claim 8, wherein the classifier is a layer of the BERT model.

15. A method of displaying an answer of a question-answer pair in response to a natural language search query, the method comprising:
receiving, from a Bidirectional Encoder Representations from Transformers (BERT) model, an array of attention matrices for the question-answer pair, wherein each attention matrix of the array of attention matrices comprises an array of attribution values;
generating a total attribution value for each word of the answer of the question-answer pair from the array of attention matrices; and
displaying the answer on an electronic display, wherein one or more words of the answer is highlighted based on the total attribution values for each word.

16. The method of claim 15, wherein each word having a total attribution value above a threshold value is highlighted.

17. The method of claim 16, wherein an attribution value for each word of the satisfactory answer is generated by:
selecting a sub-set of attention matrices of the array of attention matrices; and
for each word of the satisfactory answer, summing attribution values of the sub-set of attention matrices.

18. The method of claim 17, wherein the sub-set of attention matrices is selected by a loss function and an optimization algorithm.

19. The method of claim 18, wherein the array of attention matrices comprises a plurality of heads and a plurality of layers that are provided as input to the optimization algorithm.

20. The method of claim 15, further comprising applying a post-processing process that does one or more of the following: adds highlighting to one or more words being adjacent on both sides of word having highlighting, and removes highlighting from one or more words having a lowest total attribution when a maximum number of highlighted phrases is exceeded.
